(19) United States
(12) Patent Application Publication
(10) Pub. No.: US 2006/0254149 A1
(43) Pub. Date: Nov. 16, 2006

(54) Long trim member for vehicle and attaching method of the same

(75) Inventors: Yoichiro Kanbara, Aichi (JP); Yohsuke Kobayashi, Aichi (JP)

Correspondence Address: OLIFF & BERRIDGE, PLC, P.O. BOX 19928, ALEXANDRIA, VA, 22320, US

(73) Assignee: TOKAI KOGYO CO., LTD., Obu-city (JP)

(21) Appl. No.: 11/407,994

(22) Filed: Apr. 21, 2006

(30) Foreign Application Priority Data
Apr. 22, 2005 (JP) P2005-125000

(51) Int. Cl. B60J 1/16

(52) U.S. Cl. 49/377

(57) ABSTRACT

In a long trim member for vehicle, a first side wall of an attachment portion is formed with an elastic holding lip and an elastic sealing lip. A second side wall of the attachment portion is formed with an engagement portion and a projection ridge having a slide guide surface. When the attachment portion is pushed, a tip of the elastic sealing lip is kept not in contact with a bottom wall, a projection end of a projected flange portion is slid on the slide guide surface while the elastic holding lip is deformed elastically until the projection end of the projected flange portion passes the peak of the projection ridge. When the attachment portion is pushed further, the elastic sealing lip is deformed elastically in the direction opposite to the pushing direction and the engagement portion of the second side wall is engaged with a lock portion of the flange.

### BACKGROUND OF THE INVENTION

1. Field of the Invention

The present invention relates to a long trim member for vehicle which is attached to a flange of a vehicle body panel (including a door panel) by holding the flange from both sides and an attaching method thereof.

2. Description of the Related Art

Examples of the above kind of long trim member are a vehicle exterior side and vehicle interior side belt moldings each of which is attached to a flange (upper flange) of a door panel to thereby seal the space between the door panel and an lifting and lowering window pane, and a door opening weather strip which is attached to a flange (opening periphery flange) provided along the periphery of a door opening of a side vehicle body panel of a vehicle to thereby seal the boundary between the door and the periphery of the door opening of the vehicle body panel.

The flange of a door panel has a curved bottom wall (base portion), a projected flange portion having a projected tip portion, and a lock portion which is located closer to an interior side of a vehicle than the bottom wall.

On the other hand, in the long trim member, an attachment portion (main body) which is to be attached to the projection end of the projected flange portion and to be pushed toward the projected flange portion has first and second side walls opposed to each other via a prescribed interval and a top wall connecting the first and second side walls to form an integral member and an opening and is generally U-shaped in a sectional view.

The opposed inner surfaces of the first and second side walls are formed with respective holding lips for holding the projected flange portion from both sides. Further, a thin lip projects (extends) from an opening-side end portion of the first side wall toward the bottom wall of the flange, and an opening-side end portion of the second side wall is formed with an engagement portion capable of being engaged with the lock portion of the flange. The long trim member having the above structure is known from JP-A-2004-291704, for example.

### SUMMARY OF THE INVENTION

Meanwhile, in the long trim member disclosed in JP-A-2004-291704, to attach the long trim member by pushing the attachment portion toward the projected flange portion of a vehicle panel (door panel), it is necessary to push the attachment portion while elastically deforming the holding lips formed on the inner surfaces of the first and second side walls and the thin lip formed on the end portion of the first side wall. This requires a strong pushing force.

In particular, where the main part of the attachment portion which is generally U-shaped in a sectional view is a rigid metal plate or a core member which is generally U-shaped in a sectional view is buried in the attachment portion, it is not easy to elastically deform the first and second side walls of the attachment portion in the opening directions. Therefore, in this case, a stronger pushing force needs to be exerted on the projected flange portion of the door panel.

In a vehicle assembly line, work of attaching a long trim member is manual work performed by an operator and hence imposes an unduly heavy physical load on the operator.

The present invention has been made in view of the above problems, and an object of the invention is to provide a long trim member for vehicle which can easily be attached to a flange of a vehicle body panel with a small pushing force, and an attaching method thereof.

According to a first aspect of the invention, there is provided a long trim member for vehicle to be attached to a flange that is provided at a periphery of an opening of a vehicle body panel and has a curved bottom wall, a projected flange portion and a lock portion located closer to an interior side of a vehicle than the bottom wall, the long trim member including: an attachment portion generally U-shaped in a cross section and having first and second side walls opposed to each other at a predetermined interval, a top wall integrally connecting the first and second side walls and an opening, wherein the long trim member is attached to the flange in such a manner that the attachment portion is pushed toward a projection end of the projected flange portion of the flange through the opening thereof and the projected flange portion is thereby held from both sides, characterized in that the first side wall is formed with at least one elastic holding lip projecting from an inner surface of the first side wall toward a top wall side of an inner surface of the second side wall and an elastic sealing lip projecting and extending from an opening-side end of the first side wall toward the bottom wall of the flange, the second side wall is formed with a projection ridge projecting from a portion, closer to the top wall than a tip of the elastic holding lip, of the inner surface of the second side wall toward the inner surface of the first side wall and having a slide guide surface located on the side of the opening and forming an acute angle with the second side wall and an engagement portion located closer to the opening than the projection ridge and being capable of engagement with the lock portion of the flange, and the attachment portion is attached to the flange by pushing the attachment portion toward the projection end of the projected flange portion through the opening of the attachment portion in such a manner that a tip of the elastic sealing lip is kept not in contact with the bottom wall of the flange and a space is formed between them in a state that the slide guide surface of the projection ridge is in contact with the projection end of the projected flange portion and the tip of the elastic holding lip is in contact with a first-side-wall-side surface of the projected flange portion, that when the attachment portion is pushed further the projection end of the projected flange portion is slid on the slide guide surface while the elastic holding lip is deformed elastically toward the inner surface of the first side wall until the projection end of the projected flange portion passes a peak of the projection ridge, that when the attachment portion is pushed further the tip of the elastic sealing lip touches the bottom wall of the flange, and that when the attachment portion is pushed even further the elastic sealing lip is deformed elastically in a direction opposite to an attachment portion pushing direction and the engagement portion of the second side wall is engaged with the lock portion of the flange.

With the above configuration, to attach the long trim member to the flange of the vehicle panel by pushing the attachment portion toward the projection end of the projected flange portion through the opening of the attachment portion, first the slide guide surface of the projection ridge is slid on the projection end of the projected flange portion, whereby the elastic holding lip is deformed elastically toward the inner surface of the first side wall by part of the pushing force. The projection ridge is slid on the projection end of the projected flange portion until the projection end of the projected flange portion passes the peak of the projection ridge. During that course, the tip of the elastic sealing lip and the bottom wall (base portion) of the flange are kept not in contact with each other. When the attachment portion is pushed further, the tip of the elastic sealing lip touches the bottom wall of the flange. When the attachment portion is pushed even further, the elastic sealing lip is deformed elastically in the direction opposite to the attachment portion pushing direction and the engagement portion of the second side wall is engaged with the lock portion of the flange. The work of attaching the long trim member to the flange of the vehicle panel is thus completed.

Therefore, according to the long trim member for vehicle of the first aspect, when the attachment portion is pushed toward the projection end of the projected flange portion through the opening of the attachment portion, the elastic sealing lip is deformed elastically by utilizing part of the pushing force for pushing the attachment portion while sliding the slide guide surface of the projection ridge on the projection end of the projected flange portion, and the elastic deformation of the elastic sealing lip is delayed from that of the elastic holding lip. As a result, the pushing force to be exerted on the projected flange portion can be made smaller, as the force that is necessary for the elastic deformation of the elastic sealing lip is unnecessary, than in the case where the elastic holding lip and the elastic sealing lip are deformed elastically approximately at the same time. This makes it possible to not only efficiently perform the work of attaching the long trim member to the flange but also prevent unexpected deformation or the like because no unduly strong force is exerted on the long trim member during the attachment work.

According to a second aspect of the invention, in the long trim member for vehicle according to the first aspect, in a state that the attachment portion is attached to the flange, the elastic sealing lip provides elastic repulsive force in a direction opposite to the attachment portion pushing direction to pull the second side wall toward the projected flange portion.

Therefore, the long trim member for vehicle according to the second aspect of the invention provides, in addition to the advantages of the first aspect, an advantage that the long trim member can be attached to the flange stably because the second side wall is pulled toward the projected flange portion by the elastic repulsive force of the elastic sealing lip.

According to a third aspect of the invention, in the long trim member according to the first aspect, a positioning seat to be brought into contact with a second-side-wall-side surface of the projected flange portion is further formed and projects from the inner surface of the second side wall at a position closer to the opening than the projection ridge.

Therefore, the long trim member for vehicle according to the third aspect of the invention provides, in addition to the advantages of the first aspect, an advantage that the long trim member can be attached stably without wobble because it is positioned in a state that the projection ridge and the positioning seat on the inner surface of the second side wall are brought into contact with the second-side-wall-side surface of the projected flange portion.

According to a fourth aspect the invention, in the long trim member for vehicle according to the first aspect, the engagement portion is a projection portion which projects from a tip of the second side wall toward the first side wall.

Therefore, the long trim member for vehicle according to the fourth aspect of the invention provides, in addition to the advantages of the first aspect, an advantage that the long trim member can be attached to the flange with the engagement portion of the second side wall engaged reliably with the lock portion of the flange.

According to a fifth aspect of the invention, in the long trim member for vehicle according to the first aspect, a second elastic holding lip is further formed and projects from the inner surface of the first side wall toward the second side wall at a position closer to the top wall than the elastic holding lip.

Therefore, the long trim member according to the fifth aspect of the invention provides, in addition to the advantages of the first aspect, an advantage that in a state that the long trim member is attached to the flange, the elastic repulsive force of the second elastic holding lip which is located at the position closer to the top wall than the elastic holding lip of the first side wall adds to the elastic repulsive force of the latter, which increases the force of attaching the long trim member to the flange.

According to a sixth aspect of the invention, in the long trim member according to the first aspect, the long trim member is a belt molding to be attached to an upper flange of a door panel, and an outer surface of the second side wall is formed with a window sealing lip which is integral with the second side wall, projects toward a side window pane, and is capable of coming into elastic contact with the side window pane.

Therefore, the long trim member for vehicle according to the sixth aspect of the invention provides, in addition to the advantages of the first aspect, an advantage that the belt molding being the long trim member can easily be attached to the upper flange of the door panel with a small pushing force.

According to a seventh aspect of the invention, in the long trim member according to the first aspect, the long trim member is a door opening weather strip to be attached to a flange of a periphery of a door opening.

Therefore, the long trim member according to the seventh aspect of the invention provides, in addition to the advantages of the first aspect, an advantage that the door opening weather strip being the long trim member can easily be attached to the flange of a vehicle body panel with a small pushing force.

According to an eighth aspect of the invention, in the long trim member according to the first aspect, the elastic sealing lip is formed so as to project obliquely with respect to the bottom wall of the flange and touch it and to be deformed elastically in a direction opposite to the attachment portion pushing direction and to pull the second side wall toward the projected flange portion in a state that the attachment portion is attached to the flange.

Therefore, the long trim member for vehicle according to the eighth aspect of the invention provides, in addition to the advantages of the first aspect, an advantage that the elastic repulsive force of the elastic sealing lip acts satisfactorily in the direction opposite to the attachment portion pushing direction and pulls the second side wall toward the projected flange portion and, by virtue of the elastic repulsive force of the elastic sealing lip, the long trim member can be attached to the flange stably and satisfactorily.

According to a ninth aspect of the invention, there is provided a long trim member attaching method for attaching a long trim member to a flange that is provided at a periphery of an opening of a vehicle body panel and has a curved bottom wall, a projected flange portion and a lock portion located closer to an interior side of a vehicle than the bottom wall, the long trim member being provided with an attachment portion generally U-shaped in a cross section and having first and second side walls opposed to each other at a predetermined interval, a top wall integrally connecting the first and second side walls and an opening, the first side wall being formed with at least one elastic holding lip projecting from an inner surface of the first side wall toward a top wall side of an inner surface of the second side wall and an elastic sealing lip projecting and extending from an opening-side end of the first side wall toward the bottom wall of the flange, the second side wall being formed with a projection ridge projecting from a portion, closer to the top wall than a tip of the elastic holding lip, of the inner surface of the second side wall toward the inner surface of the first side wall and having a slide guide surface located on the side of the opening and forming an acute angle with the second side wall and an engagement portion located closer to the opening than the projection ridge and being capable of engagement with the lock portion of the flange, the long trim member attaching method for attaching the attachment portion to the flange by pushing the attachment portion toward the projection end of the projected flange portion through the opening of the attachment portion including the steps of: establishing a state that a tip of the elastic sealing lip is not in contact with the bottom wall of the flange and a space is formed between them, the slide guide surface of the projection ridge is in contact with the projection end of the projected flange portion, and the tip of the elastic holding lip is in contact with a first-side-wall-side surface of the projected flange portion; pushing the attachment portion so that the slide guide surface is slid on the projection end of the projected flange portion while the elastic holding lip is deformed elastically toward the inner surface of the first side wall until the projection end of the projected flange portion passes a peak of the projection ridge; pushing the attachment portion further so that the tip of the elastic sealing lip touches the bottom wall of the flange; pushing the attachment portion even further so that the elastic sealing lip is deformed elastically in a direction opposite to an attachment portion pushing direction and the engagement portion of the second side wall is moved to such a position as to be able to engage with the lock portion of the flange; and causing the elastic sealing lip to return to an original shape thereof due to elastic repulsive force of the elastically deformed elastic sealing lip, and thereby moving the attachment portion in a direction opposite to the attachment portion pushing direction and moving the engagement portion to the lock portion so that they are engaged with each other.

The long trim member attaching method according to the ninth aspect includes a case that the constituent steps are executed continuously in the work of attaching the long trim member to the flange.

With the above constitution, to push the attachment portion toward the projection end of the projected flange portion through the opening of the attachment portion, first the slide guide surface of the projection ridge is slid on the projection end of the projected flange portion, whereby the elastic holding lip is deformed elastically toward the inner surface of the first side wall by part of the pushing force. The attachment portion is slid until the projection end of the projected flange portion passes the peak of the projection ridge. During that course, the tip of the elastic sealing lip and the bottom wall of the flange are kept not in contact with each other.

Therefore, according to the long trim member attaching method of the ninth aspect, when the attachment portion is pushed toward the projection end of the projected flange portion, the elastic holding lip is deformed elastically by utilizing part of the pushing force for pushing the attachment portion while sliding the slide guide surface of the projection ridge on the projection end, and the elastic deformation of the elastic sealing lip is delayed from that of the elastic holding lip. As a result, the pushing force to be exerted on the projected flange portion can be made smaller, as the force that is necessary for the elastic deformation of the elastic sealing lip is unnecessary, than in the case where the elastic holding lip and the elastic sealing lip are deformed elastically approximately at the same time.

This makes it possible to not only efficiently perform the work of attaching the long trim member to the flange but also prevent unexpected deformation or the like because no unduly strong force is exerted on the long trim member during the attachment work.

When the attachment portion is pushed further to a prescribed position, the elastic sealing lip is deformed elastically in the direction opposite to the attachment portion pushing direction and the engagement portion of the second side wall is moved to a position where it can engage with the lock portion of the flange. As a result, the elastic repulsive force of the elastic sealing lip moves the attachment portion in the direction opposite to the attachment portion pushing direction, whereby the engagement portion of the second side wall can be engaged with the lock portion of the flange and the long trim member can thus be attached to the flange. Unexpected positional deviation or disengagement of the long trim member can be prevented.

According to a tenth aspect of the invention, in the long trim member attaching method according to the ninth aspect, elastic repulsive force of the elastic holding lip acts in addition to the elastic repulsive force of the elastic sealing lip in moving the engagement portion to the lock portion.

Therefore, the long trim member attaching method according to the tenth aspect of the invention provides, in addition to the advantages of the ninth aspect, an advantage that since the elastic repulsive force of the elastic holding lip acts in addition to the elastic repulsive force of the elastic sealing lip in moving the engagement portion to the lock portion, the engagement portion of the second side wall can be engaged with the lock portion of the flange more reliably, whereby unexpected positional deviation or disengagement of the long trim member can be prevented satisfactorily.

According to an eleventh aspect of the invention, in the long trim member attaching method according to the ninth aspect, the tip of the elastic sealing lip is not in contact with the bottom wall of the flange and a space is formed between them when the projection end of the projected flange portion passes the peak of the projection ridge.

Therefore, the long trim member attaching method according to the eleventh aspect of the invention provides, in addition to the advantages of the ninth aspect, an advantage that since the tip of the elastic sealing lip is kept not in contact with the bottom wall of the flange and a space is formed between them until the projection end of the projected flange portion passes the peak of the projection ridge, the work of attaching the long trim member to the flange by pushing the long trim member can be performed more efficiently.

According to a twelfth aspect of the invention, there is provided a long trim member for vehicle to be attached to a flange that is provided at a periphery of an opening of a vehicle body panel and having a curved bottom wall and a projected flange portion, the long trim member including: an attachment portion generally U-shaped in a cross section and having first and second side walls opposed to each other at a predetermined interval, a top wall integrally connecting the first and second side walls and an opening, wherein the long trim member is attached to the flange in such a manner that the attachment portion is pushed toward a projection end of the projected flange portion of the flange through the opening thereof and the projected flange portion is thereby held from both sides, characterized in that the second side wall is formed with at least one elastic holding lip projecting from an inner surface of the second side wall toward a top wall side of an inner surface of the first side wall, wherein the first side wall is formed with a projection ridge projecting from a portion, closer to the top wall than a tip of the elastic holding lip, of the inner surface of the first side wall toward the inner surface of the second side wall and having a slide guide surface located on the side of the opening and forming an acute angle with the first side wall and an elastic sealing lip projecting and extending from an opening-side end of the first side wall toward the bottom wall of the flange, wherein the attachment portion is attached to the flange by pushing the attachment portion toward the projection end of the projected flange portion through the opening of the attachment portion in such a manner that a tip of the elastic sealing lip is kept not in contact with the bottom wall of the flange and a space is formed between them in a state that the slide guide surface of the projection ridge is in contact with the projection end of the projected flange portion and the tip of the elastic holding lip is in contact with a second-side-wall-side surface of the projected flange portion, that when the attachment portion is pushed further the slide guide surface is slid on the projection end of the projected flange portion while the elastic holding lip is deformed elastically toward the inner surface of the second side wall until the projection end of the projected flange portion passes a peak of the projection ridge, that when the attachment portion is pushed further the projected flange portion is held between the elastic holding lip and the projection ridge wherein the elastic holding lip exerting holding force of an elastic repulsive force to the projected flange portion, and that when the attachment portion is pushed even further the elastic sealing lip is deformed elastically in a direction opposite to an attachment portion pushing direction to attach the attachment portion and when the attachment portion is attached to the flange, an elastic repulsive force of the elastic sealing lip acting in a direction opposite to the attachment portion pushing direction, and wherein holding force of the elastic repulsive force of the elastic holding lip is set stronger than the elastic repulsive force of the elastic sealing lip.

With the above configuration, to push the attachment portion toward the projection end of the projected flange portion through the opening of the attachment portion, first the slide guide surface of the projection ridge is slid on the projection end of the projected flange portion, whereby the elastic holding lip is deformed elastically toward the inner surface of the second side wall by part of the pushing force. The attachment portion is slid until the projection end of the projected flange portion passes the peak of the projection ridge. During that course, the tip of the elastic sealing lip and the bottom wall of the flange are kept not in contact with each other.

Therefore, according to the long trim member for vehicle of the twelfth aspect, when the attachment portion is pushed toward the projection end of the projected flange portion through the opening of the attachment portion, the elastic holding lip is deformed elastically by utilizing part of the pushing force for pushing the attachment portion while sliding the slide guide surface of the projection ridge on the projected end, and the elastic deformation of the elastic sealing lip is delayed from that of the elastic holding lip. As a result, the pushing force to be exerted on the projected flange portion can be made smaller, as the force that is necessary for the elastic deformation of the elastic sealing lip is unnecessary, than in the case where the elastic holding lip and the elastic sealing lip are deformed elastically approximately at the same time.

This makes it possible to not only efficiently perform the work of attaching the long trim member to the flange but also prevent unexpected deformation or the like because no unduly strong force is exerted on the long trim member during the attachment work.

In an attached state, the elastic repulsive force of the elastic sealing lip acts in the direction opposite to the attachment portion pushing direction and the elastic repulsive force of the elastic holding lip acts in a direction toward the projected flange portion. In this state, the holding force of the elastic repulsive force of the elastic holding lip is stronger than the elastic repulsive force of the elastic sealing lip. Therefore, the state that the long trim member is attached to the flange can be maintained. Further, since the elastic repulsive force of the elastic sealing lip keeps itself in elastic contact with the bottom wall of the flange, sealing is maintained at the boundary between the elastic sealing lip and the bottom wall of the flange.

According to a thirteenth aspect of the invention, there is provided a long trim member attaching method for attaching a long trim member to a flange that is provided at a periphery of an opening of a vehicle body panel and having a curved bottom wall and a projected flange portion, the long trim member being provided with an attachment portion generally U-shaped in a cross section and having first and second side walls opposed to each other at a predetermined interval and a top wall integrally connecting the first and second side walls and an opening, the second side wall being formed with at least one elastic holding lip projecting from an inner surface of the second side wall toward a top wall side of an inner surface of the first side wall, the first side wall being formed with a projection ridge projecting from a portion, closer to the top wall than a tip of the elastic holding lip, of the inner surface of the first side wall toward the inner surface of the second side wall and having a slide guide surface located on the side of the opening and forming an acute angle with the first side wall and an elastic sealing lip projecting and extending from an opening-side end of the first side wall toward the bottom wall of the flange, the long trim member attaching method for attaching the attachment portion to the flange by pushing the attachment portion toward the projection end of the projected flange portion through the opening of the attachment portion including the steps of: establishing a state that a tip of the elastic sealing lip is not in contact with the bottom wall of the flange and a space is formed between them, the slide guide surface of the projection ridge is in contact with the projection end of the projected flange portion, and the tip of the elastic holding lip is in contact with a second-side-wall-side surface of the projected flange portion; pushing the attachment portion so that the slide guide surface is slid on the projection end of the projected flange portion while the elastic holding lip is deformed elastically toward the inner surface of the second side wall until the projection end of the projected flange portion passes a peak of the projection ridge; pushing the attachment portion further so that the projected flange portion is held between the elastic holding lip and the projection ridge; pushing the attachment portion even further so that the elastic sealing lip is deformed elastically in a direction opposite to an attachment portion pushing direction; and causing the elastically deformed elastic sealing lip to generate elastic repulsive force because it is urged to return to an original shape thereof.

The long trim member attaching method according to the thirteenth aspect includes a case that the constituent steps are executed continuously in the work of attaching the long trim member to the flange.

With the above constitution, to push the attachment portion toward the projection end of the projected flange portion through the opening of the attachment portion, first the slide guide surface of the projection ridge is slid on the projection end of the projected flange portion, whereby the elastic holding lip is deformed elastically toward the inner surface of the second side wall by part of the pushing force. The attachment portion is slid until the projection end of the projected flange portion passes the peak of the projection ridge. During that course, the tip of the elastic sealing lip and the bottom wall of the flange are kept not in contact with each other.

Therefore, according to the long trim member attaching method of the thirteenth aspect, when attachment portion is pushed toward the projection end of the projected flange portion through the opening of the attachment portion, the elastic holding lip is deformed elastically by utilizing part of the pushing force for pushing the attachment portion toward the projection end of the projected flange portion while sliding the slide guide surface of the projection ridge on the projection end, and the elastic deformation of the elastic sealing lip is delayed from that of the elastic holding lip. As a result, the pushing force to be exerted on the projected flange portion can be made smaller, as the force that is necessary for the elastic deformation of the elastic sealing lip is unnecessary, than in the case where the elastic holding lip and the elastic sealing lip are deformed elastically approximately at the same time.

This makes it possible to not only efficiently perform the work of attaching the long trim member to the flange but also prevent unexpected deformation or the like because no unduly strong force is exerted on the long trim member during the attachment work.

### BRIEF DESCRIPTION OF THE DRAWINGS

FIG. 1 is a side view showing, in a simplified manner, a state that a belt molding as a long trim member according to a first embodiment of the present invention is attached to a vehicle door panel;

FIG. 2 is a sectional view taken along line II-II in FIG. 1;

FIG. 3 is a sectional view showing a halfway state of a process of attaching the belt molding to a flange of the door panel;

FIG. 4 is a sectional view showing a state that the belt molding is attached to the flange of the door panel;

FIG. 5 is a sectional view showing a state that a door opening weather strip as a long trim member according to a second embodiment of the invention is attached to a flange of a vehicle body panel; and

FIG. 6 is a sectional view showing a halfway state of a process of attaching the door opening weather strip to the flange of the vehicle body panel.

### DETAILED DESCRIPTION OF THE PREFFERED EMBODIMENTS

Now, embodiments of the present invention will be described.

### Embodiment 1

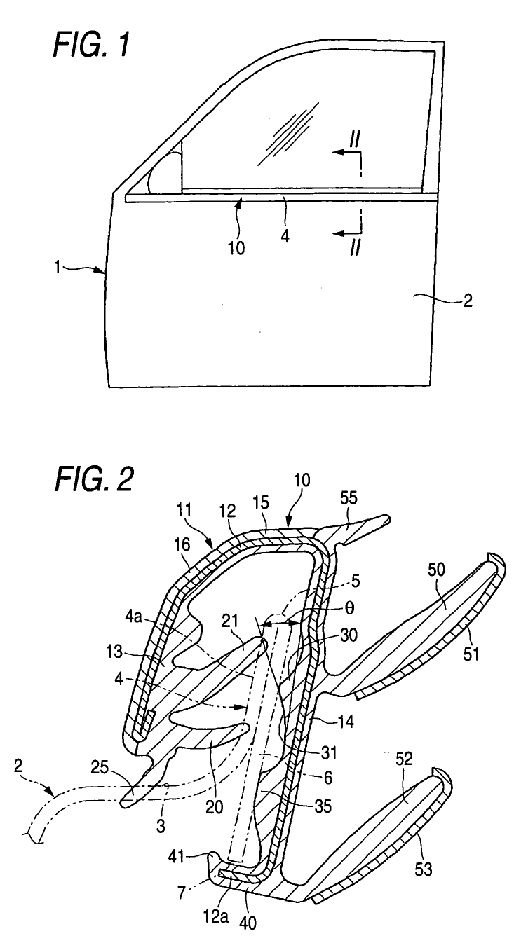

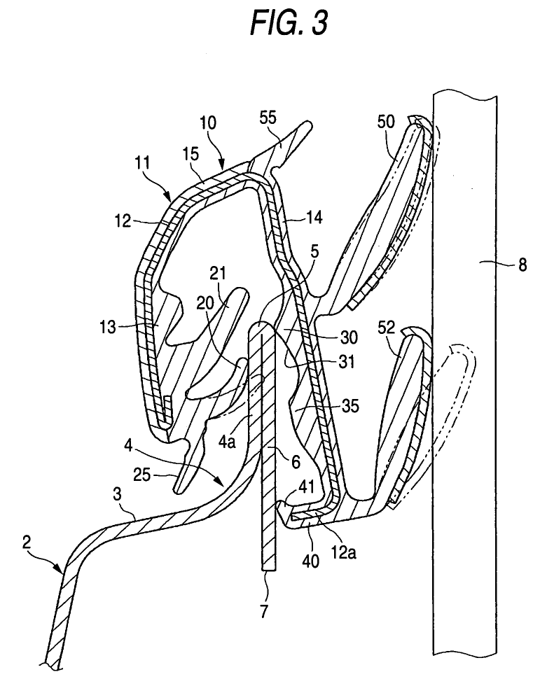

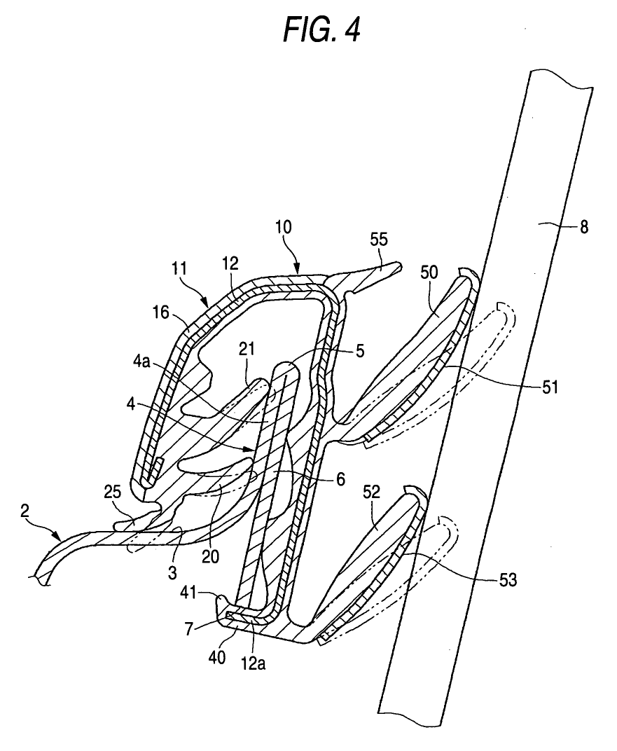

FIG. 1 is a side view showing, in a simplified manner, a state that a belt molding as a long trim member is attached to a vehicle door panel. FIG. 2 is a sectional view taken along line II-II in FIG. 1. FIG. 3 is a sectional view showing a halfway state of a process of attaching the belt molding to a flange of the door panel. FIG. 4 is a sectional view showing a state that the belt molding is attached to the flange of the door panel.

As shown in FIGS. 1 and 2, a flange 4 which is provided at an upper edge of a door panel 2 of a vehicle door 1 (although a front door is shown in FIG. 1, it may be a rear door) which is attached to a side portion of the vehicle is provided with a curved bottom wall 3 as a base portion (lower portion) which projects toward the exterior side of the vehicle, a projected flange portion 4a which projects upward, and a lock portion 7 which is formed at the bottom end of a return piece 6 which extends downward from a projection end 5 (folding line) of the projected flange portion 4a.

The belt molding 10, formed as a long member by extrusion molding using such a material as a thermoplastic elastomer (e.g., TPO) or rubber, is attached along the flange 4 so as to extend parallel with the longitudinal direction of the flange 4.

As shown in FIG. 2, an attachment portion 11 as a main body of the belt molding 10 has first and second side walls 13 and 14 which are opposed to each other at a predetermined interval and a top wall 15 which connects the first and second side walls 13 and 14 to form an integral member and an opening. As such, the attachment portion 11 is generally U-shaped in the sectional view.

When pushed toward the projected flange portion 4a in a state that the projection end 5 of the projected flange portion 4a has been inserted through the opening of the attachment portion 11, the belt molding 10 holds the projected flange portion 4a (including the return piece 6) from both sides and is thereby attached to the flange 4.

As shown in FIG. 2, the first side wall 13 (in the first embodiment, the vehicle exterior side wall) of the attachment portion 11 is formed with at least one elastic holding lip which projects from the inner surface of the first side wall 13 toward a top wall side of the inner surface of the second side wall 14 (in the first embodiment, the vehicle interior side wall).

In the first embodiment, a tongue-shaped first elastic holding lip 20 projects from a portion, close to the opening, of the inner surface of the first side wall 13 toward the second side wall 14. A tongue-shaped second elastic holding lip 21 projects from a portion, closer to the top wall 15, of the inner surface of the first side wall 13 toward the second side wall 14.

Further, an elastic sealing lip 25 projects (extends) from the opening-side end of the first side wall 13 of the attachment portion 11 toward the bottom wall 3 of the flange 4.

In the first embodiment, the elastic sealing lip 25 is formed so as to project obliquely with respect to the bottom wall 3 of the flange 4 and touch it so that elastic repulsive force acts in the direction opposite to the attachment portion 11 pushing direction and the second side wall is pulled 14 toward the projected flange portion 4a (i.e. , toward the exterior of the vehicle) in a state that the attachment portion 11 is attached.

As shown in FIG. 2, a projection ridge 30 projects from a portion, closer to the top wall 15 than the tip of the first elastic holding lip 20, of the inner surface of the second side wall 14 of the attachment portion 11 toward the inner surface of the first side wall 13 so as to form a generally mountain-like shape in the sectional view and to extend continuously in the longitudinal direction.

The opening-side surface of the projection ridge 30 is a slide guide surface 31 which forms an acute angle θ with the second side wall 14.

A positioning seat 35 which is to contact the surface of the return piece 6 of the projected flange portion 4a so that the attachment portion 11 supports the flange 4 while being positioned with respect to it in a prescribed attachment posture projects from a portion, closer to the opening than the projection ridge 30 is, of the inner surface of the second side wall 14 so as to form, in the sectional view, a generally trapezoidal shape which is gentler than the projection ridge 30.

A tip portion of the second side wall 14 is shaped into an engagement portion 40 which is a projection portion projecting toward the first side wall 13 so as to form an approximately right angle with the second side wall 14 and which can be engaged with the lock portion 7 of the flange 4. A disengagement prevention projection 41 is formed at the tip of the engagement portion 40 so as to project upward.

In the first embodiment, the shapes, sizes, and locations of the first elastic holding lip 20, the elastic sealing lip 25, and the projection ridge 30 of the attachment portion 11 are set so that the attachment portion 11 is attached to the flange 4 in the following manner by pushing the attachment portion 11 toward the projection end 5 of the projected flange portion 4a through its opening. First, in a state that the projection end 5 of the projected flange portion 4a is in contact with the slide guide surface 31 of the projection ridge 30 and the tip of the first elastic holding lip 20 is in contact with the first-side-wall-side surface of the projected flange portion 4a, the tip of the elastic sealing lip 25 is set not in contact with the bottom wall 3 of the flange 4 (i.e., a space is formed between them). The attachment portion 11 is pushed, whereby the projection end 5 of the projected flange portion 4a is slid on the slide guide surface 31 while the first elastic holding lip 20 is deformed elastically toward the inner surface of the first side wall 13 until the projection end 5 of the projected flange portion 4a passes the peak of the projection ridge 30 (see FIG. 3). The attachment portion 11 is pushed further, whereby the tip of the elastic sealing lip 25 touches the bottom wall 3 of the flange 4. The attachment portion 11 is pushed even further (see FIG. 4), whereby the elastic sealing lip 25 is deformed elastically in the direction opposite to the pushing direction and the engagement portion 40 of the second side wall 14 is engaged with the lock portion 7 of the flange 4 to complete the work of attaching the attachment portion 11.

In the first embodiment, as shown in FIG. 4, the outer surface (i.e., vehicle-interior side surface) of the second side wall 14 of the attachment portion 11 is formed with one or plural window sealing lips 50 and 52 (in the first embodiment, two sealing lips are arranged in the vertical direction) which are integral with the second side wall 14, project toward a lifting and lowering window pane 8, and can come into elastic contact with the window pane 8. The vehicle-interior side surfaces (i.e., the surfaces to contact the window pane 8) of the sealing lips 50 and 52 are provided with flocking 51 and 53 or low-friction layers.

A tongue-shaped top lip 55 is formed integrally with the attachment portion 11 so as to project obliquely upward from the outer surface of the attachment portion 11 at the boundary between the top of the second side wall 14 and the top wall 15.

The vehicle-exterior design surface of the first side wall 13 and the top wall 15 are provided with a design layer 16.

In the first embodiment, it is preferable that the attachment portion 11, excluding the design layer 16, the first elastic holding lip 20, the second elastic holding lip 21, the elastic sealing lip 25, the projection ridge 30, the positioning seat 35, the engagement portion 40, the top lip 55, and the sealing lips 50 and 52 excluding the flocking 51 and 53 of the belt molding 10 be made of a soft or semi-hard thermoplastic resin or thermoplastic elastomer material exhibiting a JISK 7215 durometer hardness HDA of about 70. It is even preferable that they be made of a material that is mainly an olefin-type thermoplastic elastomer (TPO) material.

It is preferable that the design layer 16 be made of a hard thermoplastic resin or thermoplastic elastomer material exhibiting a JISK 7215 durometer hardness HDA of about 100. It is even preferable that the design layer 16 be made of a material that is mainly an olefin-type thermoplastic elastomer (TPO) material.

Olefin-type thermoplastic elastomer (TPO) materials are light and can be obtained easily.

In the first embodiment, a core member 12 which is a rigid metal plate (e.g., stainless steel plate) and is generally U-shaped in the sectional view is buried in the attachment portion 11 of the belt molding 10 approximately at the center in its thickness direction at the time of the extrusion molding, whereby the attachment portion 11 is given desired rigidity.

Further, a reinforcement portion 12a for reinforcing the engagement portion 40 is formed by right-angled bending so as to extend from the bottom end of that portion of the core member 12 which is buried in the second side wall 14.

The belt molding 10 as the long trim member according to the first embodiment is configured in the above-described manner.

Therefore, to attach the belt molding 10 to the flange 4 of the door panel 2, that is, to push the attachment portion 11 toward the projection end 5 of the projected flange portion 4a through its opening, first, a state is established that the tip of the elastic sealing lip 25 and the bottom wall 3 of the flange 4 are not in contact with each other (i.e., a space is formed between them), the projection end 5 of the projected flange portion 4a is in contact with the slide guide surface 31 of the projection ridge 30, and the tip of the first elastic holding lip 20 is in contact with the first-side-wall-side surface of the projected flange portion 4a.

After the above step, as shown in FIG. 3, the attachment portion 11 is pushed toward the projected flange portion 4a, whereby the projection end 5 of the projected flange portion 4a is slid on the slide guide surface 31 while the first elastic holding lip 20 is deformed elastically toward the inner surface of the first side wall 13 until the projection end 5 of the projected flange portion 4a passes the peak of the projection ridge 30 (i.e., until the peak of the projection ridge 30 reaches the surface of the return piece 6). In this step, the state that the tip of the elastic sealing lip 25 and the bottom wall 3 of the flange 4 are not in contact with each other (i.e., a space is formed between them) is maintained.

The attachment portion 11 is pushed further, whereby the tip of the elastic sealing lip 25 touches the bottom wall 3 of the flange 4. The attachment portion 11 is pushed even further, whereby the elastic sealing lip 25 is deformed elastically in the direction opposite to the pushing direction and the engagement portion 40 of the second side wall 14 is moved to a position where it can be engaged with the lock portion 7 of the flange 4.

After the above step, the elastic sealing lip 25 is returned to the original shape by the elastic repulsive force of the elastically deformed elastic sealing lip 25, whereby the attachment portion 11 is moved in the direction opposite to the pushing direction and the engagement portion 40 is moved to and engaged with the lock portion 7 (see FIG. 4).

The work of attaching the belt molding 10 to the flange 4 of the door panel 2 is completed by executing the above steps.

As described above, the first elastic holding lip 20 is deformed elastically by utilizing part of the pushing force for pushing the attachment portion toward the projection end 5 of the projected flange portion 4a while sliding the slide guide surface 31 of the projection ridge 30 on the projection end 5, and the elastic deformation of the elastic sealing lip 25 is delayed from that of the first elastic holding lip 20. As a result, the pushing force to be exerted on the projected flange portion 4a can be made smaller, as the force that is necessary for the elastic deformation of the elastic sealing lip 25 is unnecessary, than in the case where the first elastic holding lip 20 and the elastic sealing lip 25 are deformed elastically approximately at the same time.

This makes it possible to not only efficiently perform the work of attaching the belt molding 10 to the projected flange portion 4a but also prevent unexpected deformation or the like because no unduly strong force is exerted on the belt molding 10 during the attachment work.

The attachment portion 11 is pushed toward the projected flange portion 4a to a prescribed position, whereby the elastic sealing lip 25 is deformed elastically in the direction opposite to the pushing direction and the engagement portion 40 of the second side wall 14 is moved to a position where it can be engaged with the lock portion 7 of the flange 4. As a result, the attachment portion 11 is moved in the opposite direction to the pushing direction by the elastic repulsive force of the elastic sealing lip 25 and the engagement portion 40 of the second side wall 14 can thereby be engaged with the lock portion 7 of the flange 4. This completes the work of attaching the belt molding 10 to the flange 4. Unexpected positional deviation or disengagement of the belt molding 10 can thus be prevented. And in a state that the belt molding 10 is attached to the flange 4, the elastic repulsive force of the first elastic holding lip 20 acts satisfactory in a direction toward the projected flange portion.

In the first embodiment, to move the engagement portion 40 toward the lock portion 7, the elastic repulsive force of the first elastic holding lip 20 (and that of the second elastic holding lip 21 in the first embodiment) is utilized in addition to the elastic repulsive force of the elastic sealing lip 25. Therefore, the engagement portion 40 of the second side wall 14 can be engaged with the lock portion 7 of the flange more reliably, which makes it possible to prevent unexpected positional deviation or disengagement of the belt molding 10 satisfactorily.

In the first embodiment, the positioning seat 35 projects from the inner surface of the second side wall 14 and the attachment portion 11 is positioned in such a manner that the positioning seat 35 and the projection ridge 30 formed on the inner surface of the second side wall 14 are in contact with the surface of the return piece 6 of the projected flange portion 4a. Therefore, the belt molding 10 can be attached and held stably without wobble in a prescribed attachment posture.

Since the engagement portion 40 is the projection portion that projects toward the first side wall 13 from the tip of the second side wall 14, the belt molding 10 can be attached to the flange 4 with the engagement portion 40 engaged with the lock portion 7 of the flange 4 reliably.

In the first embodiment, the second elastic holding lip 21 projects toward the second side wall 14 from the inner surface of the first side wall 13 at the position closer to the top wall 15 than the first elastic holding lip 20. Therefore, in a state that the belt molding 10 is attached to the flange 4, the elastic repulsive force of the second elastic holding lip 21 which is located at the position closer to the top wall 15 than the first elastic holding lip 20 adds to the elastic repulsive force of the first elastic holding lip 20, which increases the force of attaching the belt molding 10 to the flange 4.

In the first embodiment, the elastic sealing lip 25 is formed so as to project obliquely with respect to the bottom wall 3 of the flange 4 and touch it and to be deformed elastically in the direction opposite to the attachment portion 11 pushing direction and to pull the second side wall 14 toward the projected flange portion 4a in a state that the attachment portion 11 is attached. As a result, the elastic repulsive force of the elastic sealing lip 25 acts satisfactorily in the direction opposite to the attachment portion 11 pushing direction and the second side wall 14 is pulled toward the projected flange portion 4a. By virtue of the elastic repulsive force of the elastic sealing lip 25, the belt molding 10 can be attached to the flange stably and satisfactorily.

In this state, the holding force of the elastic repulsive force of the elastic holding lip is stronger than the elastic repulsive force of the elastic sealing lip. Therefore, the state that the long trim member is attached to the flange can be maintained. Further, since the elastic repulsive force of the elastic sealing lip keeps itself in elastic contact with the bottom wall of the flange, sealing is maintained at the boundary between the elastic sealing lip and the bottom wall of the flange.

### Embodiment 2

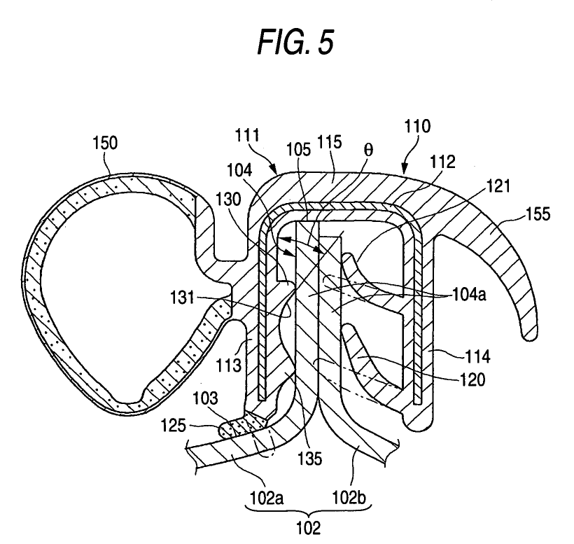

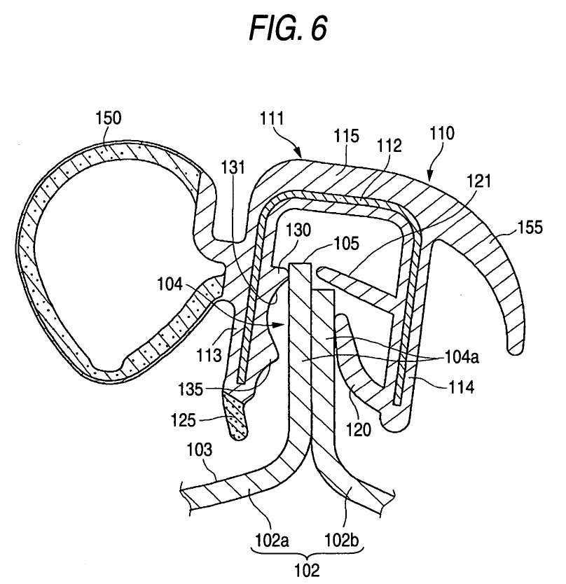

Next, a second embodiment of the invention will be described with reference to FIGS. 5 and 6.

FIG. 5 is a sectional view showing a state that a door opening weather strip as a long trim member is attached to a flange of a vehicle body panel. FIG. 6 is a sectional view showing a halfway state of a process of attaching the door opening weather strip to the flange of the vehicle body panel.

As shown in FIG. 5, the second embodiment is an example in which the long trim member is a door opening weather strip (hereinafter referred to simply as “weather strip”) 110. A flange 104 where an inner panel 102b and an outer panel 102a of a vehicle body panel 102 which defines a door opening of the vehicle body are joined to each other is provided with a curved bottom wall 103 as a base portion (lower portion) and projected flange portions 104a which project toward the center side of the door opening (reference numeral 105 denotes the tip of the projected flange portions 104a).

The weather strip 110 is formed as a long member by extrusion molding using such a material as a thermoplastic elastomer (e.g., TPO) or rubber.

As shown in FIG. 5, an attachment portion 111 as a main body of the weather strip 110 has first and second side walls 113 and 114 which are opposed to each other at a predetermined interval and a top wall 115 which connects the first and second side walls 113 and 114 to form an integral member and an opening. As such, the attachment portion 111 is generally U-shaped in the sectional view.

The attachment portion 111 is pushed toward the projection end 105 of the projected flange portions 104a through the opening of the attachment portion 111, whereby the weather strip 110 holds the projected flange portions 104a from both sides and is thereby attached to the flange 104.

As shown in FIG. 5, the second side wall 114 of the attachment portion 111 is formed with at least one elastic holding lip which projects from the inner surface of the second side wall 114 toward a top wall side of the inner surface of the first side wall 113.

In the second embodiment, a tongue-shaped first elastic holding lip 120 projects from a portion, close to the opening, of the inner surface of the second side wall 114 toward the first side wall 113. A tongue-shaped second elastic holding lip 121 projects from a dtop wall side of the inner surface of the second side wall 114 toward the first side wall 113.

As shown in FIG. 5, a projection ridge 130 projects from a portion, closer to the top wall 115 than the tip of the first elastic holding lip 120, of the inner surface of the first side wall 113 of the attachment portion 111 toward the inner surface of the second side wall 114 so as to form a generally mountain-like shape in the sectional view and to extend continuously in the longitudinal direction.

The opening-side surface of the projection ridge 130 is a slide guide surface 131 which forms an acute angle θ with the first side wall 113.

A positioning seat 135 which is to contact the first-side-wall-side surface of the projected flange portions 104a so that the attachment portion 111 supports the projected flange portions 104a while being positioned with respect to those in a prescribed attachment posture projects from a portion, closer to the opening than the projection ridge 130 is, of the inner surface of the first side wall 113 so as to form, in the sectional view, a generally mountain-like shape.

A tongue-shaped elastic sealing lip 125 projects (extends) from the opening-side end of the first side wall 113 of the attachment portion 111 toward the bottom wall 103 of the flange 104.

In the second embodiment, the elastic sealing lip 125 is formed so as to project obliquely with respect to the bottom wall 103 of the flange 104 and touch it so that elastic repulsive force acts in the direction opposite to the attachment portion 111 pushing direction and the second side wall 114 is pulled toward the projected flange portions 104a in a state that the attachment portion 111 is attached.

In the second embodiment, the shapes, sizes, and locations of the first elastic holding lip 120, the elastic sealing lip 125, and the projection ridge 130 of the attachment portion 111 are set so that the weather strip 110 is attached to the flange 104 in the following manner by pushing the attachment portion 111 toward the projection end 105 of the projected flange portions 104a through its opening. First, in a state that the projection end 105 of the projected flange portions 104a is in contact with the slide guide surface 131 of the projection ridge 130 and the tip of the first elastic holding lip 120 is in contact with the second-side-wall-side surface of the projected flange portions 104a, the tip of the elastic sealing lip 125 is set not in contact with the bottom wall 103 of the flange 104 (i.e., a space is formed between them). The attachment portion 111 is pushed, whereby the projection end 105 of the projected flange portions 104a is slid on the slide guide surface 131 while the first elastic holding lip 120 is deformed elastically toward the inner surface of the second side wall 114 until the projection end 105 of the projected flange portions 104a pass the peak of the projection ridge 130 (see FIG. 6). The attachment portion 111 is pushed further, whereby the tip of the elastic sealing lip 125 touches the bottom wall 103 of the flange 104. The attachment portion 111 is pushed even further (see FIG. 5), whereby the elastic sealing lip 125 is deformed elastically in the direction opposite to the pushing direction to complete the work of attaching the attachment portion 111.

In the attached state of FIG. 5, the elastic repulsive force of the elastic sealing lip 125 acts in the direction opposite to the pushing direction and the elastic repulsive force of the elastic holding lip 120 acts in a direction toward the projected flange portion 104a. The holding force of the elastic repulsive force of the first elastic holding lip 120 (and that of the second elastic holding lip 121 in the second embodiment) is set stronger than the elastic repulsive force of the elastic sealing lip 125.

In the second embodiment, as shown in FIG. 5, the outer surface of the first side wall 113 of the attachment portion 111 is formed with a hollow sealing portion 150 which is hollow as seen from the sectional view and is made of a foamed thermoplastic elastomer, rubber, or the like. A curved, tongue-shaped top lip 155 is formed integrally with the attachment portion 111 so as to project obliquely downward from the outer surface of the attachment portion 111 at the boundary between the top of the second side wall 114 and the top wall 115.

In the second embodiment, a punched-out core member 112 which is a rigid metal plate and is generally U-shaped in the sectional view is buried in the attachment portion 111 of the weather strip 110 approximately at the center in its thickness direction at the time of the extrusion molding, whereby the attachment portion 111 is given desired rigidity.

The weather strip 110 as the long trim member according to the second embodiment is configured in the above-described manner.

Therefore, to attach the weather strip 110 to the flange 104 of the vehicle body panel 102 which defines the door opening of the vehicle body, that is, to push the attachment portion 111 toward the projection end 105 of the projected flange portions 104a through its opening, first, a state is established that the tip of the elastic sealing lip 125 and the bottom wall 103 of the flange 104 are not in contact with each other (i.e., a space is formed between them), the projection end 105 of the projected flange portions 104a is in contact with the slide guide surface 131 of the projection ridge 130, and the tip of the first elastic holding lip 120 is in contact with the second-side-wall-side surface of the projected flange portions 104a.

After the above step, as shown in FIG. 6, the attachment portion 111 is pushed toward the projected flange portions 104a, whereby the projection end 105 of the projected flange portions 104a is slid on the slide guide surface 131 while the first elastic holding lip 120 is deformed elastically toward the inner surface of the second side wall 114 until the peak of the projection ridge 130 passes the projection end 105 of the projected flange portions 104a. In this step, the state that the tip of the elastic sealing lip 125 and the bottom wall 103 of the flange 104 are not in contact with each other is maintained.

The attachment portion 111 is pushed further, whereby the tip of the elastic sealing lip 125 touches the bottom wall 103 of the flange 104. The attachment portion 111 is pushed even further, whereby the elastic sealing lip 125 is deformed elastically in the direction opposite to the pushing direction.

After the above step, the elastically deformed elastic sealing lip 125 exerts elastic repulsive force in such a direction as to return to its original shape.

The work of attaching the weather strip 110 to the flange 104 of the vehicle body panel 102 is completed by executing the above steps.

As described above, the first elastic holding lip 120 is deformed elastically by utilizing part of the pushing force for pushing the attachment portion 111 in a state sliding the projection end 105 of the projected flange portion 104a on the slide guide surface 31 of the projection ridge 30, and the elastic deformation of the elastic sealing lip 125 is delayed from that of the first elastic holding lip 120. As a result, the pushing force to be exerted on the attachment portion 111 can be made smaller, as the force that is necessary for the elastic deformation of the elastic sealing lip 125 is unnecessary, than in the case where the first elastic holding lip 120 and the elastic sealing lip 125 are deformed elastically approximately at the same time.

This makes it possible to not only efficiently perform the work of attaching the weather strip 110 to the flange 104 but also prevent unexpected deformation or the like because no unduly strong force is exerted on the weather strip 110 during the attachment work.

In a state that the weather strip 110 is attached, the elastic repulsive force of the elastic sealing lip 125 acts in the direction opposite to the pushing direction and the elastic repulsive force of the elastic holding lip 120 acts in a direction toward the projected flange portion 104a. In this state, the holding force of the elastic repulsive force of the first elastic holding lip 120 (and that of the second elastic holding lip 121 in the second embodiment) is stronger than the elastic repulsive force of the elastic sealing lip 125. Therefore, the state that the weather strip 110 is attached to the flange 104 can be maintained. Further, since the elastic repulsive force of the elastic sealing lip 125 keeps itself in elastic contact with the bottom wall 103 of the flange 104, sealing is maintained at the boundary between the elastic sealing lip 125 and the bottom wall 103 of the flange 104.

Although the invention has been described in the form of the first and second embodiments, the invention is not limited to the first and second embodiments. The shapes, sizes, materials, etc., of the individual members may be changed as appropriate within such ranges that the object of the invention can be attained.

A low-friction layer having a small coefficient of friction against the projection end 5 (or 105) of the projected flange portion(s) 4a (or 104a) may be formed on the projection ridge 30 (or 130) and/or the slide guide surface 31 (or 131).

What is claimed is:

1. A long trim member for vehicle to be attached to a flange that is provided at a periphery of an opening of a vehicle body panel and has a curved bottom wall, a projected flange portion and a lock portion located closer to an interior side of a vehicle than the bottom wall, the long trim member including:
an attachment portion generally U-shaped in a cross section and having first and second side walls opposed to each other at a predetermined interval, a top wall integrally connecting the first and second side walls and an opening,
wherein the long trim member is attached to the flange in such a manner that the attachment portion is pushed toward a projection end of the projected flange portion of the flange through the opening thereof and the projected flange portion is thereby held from both sides,
characterized in that
the first side wall is formed with at least one elastic holding lip projecting from an inner surface of the first side wall toward a top wall side of an inner surface of the second side wall and an elastic sealing lip projecting and extending from an opening-side end of the first side wall toward the bottom wall of the flange,
the second side wall is formed with a projection ridge projecting from a portion, closer to the top wall than a tip of the elastic holding lip, of the inner surface of the second side wall toward the inner surface of the first side wall and having a slide guide surface located on the side of the opening and forming an acute angle with the second side wall and an engagement portion located closer to the opening than the projection ridge and being capable of engagement with the lock portion of the flange, and
the attachment portion is attached to the flange by pushing the attachment portion toward the projection end of the projected flange portion through the opening of the attachment portion in such a manner that a tip of the elastic sealing lip is kept not in contact with the bottom wall of the flange and a space is formed between them in a state that the slide guide surface of the projection ridge is in contact with the projection end of the projected flange portion and the tip of the elastic holding lip is in contact with a first-side-wall-side surface of the projected flange portion, that when the attachment portion is pushed further the projection end of the projected flange portion is slid on the slide guide surface while the elastic holding lip is deformed elastically toward the inner surface of the first side wall until the projection end of the projected flange portion passes a peak of the projection ridge, that when the attachment portion is pushed further the tip of the elastic sealing lip touches the bottom wall of the flange, and that when the attachment portion is pushed even further the elastic sealing lip is deformed elastically in a direction opposite to an attachment portion pushing direction and the engagement portion of the second side wall is engaged with the lock portion of the flange.

2. The long trim member for vehicle according to claim 1, wherein in a state that the attachment portion is attached to the flange, the elastic sealing lip provides elastic repulsive force in a direction opposite to the attachment portion pushing direction to pull the second side wall toward the projected flange portion.

3. The long trim member for vehicle according to claim 1, wherein a positioning seat to be brought into contact with a second-side-wall-side surface of the projected flange portion is further formed and projects from the inner surface of the second side wall at a position closer to the opening than the projection ridge.

4. The long trim member for vehicle according to claim 1, wherein the engagement portion is a projection portion which projects from a tip of the second side wall toward the first side wall.

5. The long trim member for vehicle according to claim 1, wherein a second elastic holding lip is further formed and projects from the inner surface of the first side wall toward the second side wall at a position closer to the top wall than the elastic holding lip.

6. The long trim member for vehicle according to claim 1, wherein the long trim member is a belt molding to be attached to an upper flange of a door panel, and an outer surface of the second side wall is formed with a window sealing lip which is integral with the second side wall, projects toward a side window pane, and is capable of coming into elastic contact with the side window pane.

7. The long trim member for vehicle according to claim 1, wherein the long trim member is a door opening weather strip to be attached to a flange of a periphery of a door opening.

8. The long trim member for vehicle according to claim 1, wherein the elastic sealing lip is formed so as to project obliquely with respect to the bottom wall of the flange and touch it and to be deformed elastically in a direction opposite to the attachment portion pushing direction and to pull the second side wall toward the projected flange portion in a state that the attachment portion is attached to the flange.

9. A long trim member attaching method for attaching a long trim member to a flange that is provided at a periphery of an opening of a vehicle body panel and has a curved bottom wall, a projected flange portion and a lock portion located closer to an interior side of a vehicle than the bottom wall, the long trim member being provided with an attachment portion generally U-shaped in a cross section and having first and second side walls opposed to each other at a predetermined interval, a top wall integrally connecting the first and second side walls and an opening, the first side wall being formed with at least one elastic holding lip projecting from an inner surface of the first side wall toward a top wall side of an inner surface of the second side wall and an elastic sealing lip projecting and extending from an opening-side end of the first side wall toward the bottom wall of the flange, the second side wall being formed with a projection ridge projecting from a portion, closer to the top wall than a tip of the elastic holding lip, of the inner surface of the second side wall toward the inner surface of the first side wall and having a slide guide surface located on the side of the opening and forming an acute angle with the second side wall and an engagement portion located closer to the opening than the projection ridge and being capable of engagement with the lock portion of the flange, the long trim member attaching method for attaching the attachment portion to the flange by pushing the attachment portion toward the projection end of the projected flange portion through the opening of the attachment portion comprising the steps of:
establishing a state that a tip of the elastic sealing lip is not in contact with the bottom wall of the flange and a space is formed between them, the slide guide surface of the projection ridge is in contact with the projection end of the projected flange portion, and the tip of the elastic holding lip is in contact with a first-side-wall-side surface of the projected flange portion;
pushing the attachment portion so that the slide guide surface is slid on the projection end of the projected flange portion while the elastic holding lip is deformed elastically toward the inner surface of the first side wall until the projection end of the projected flange portion passes a peak of the projection ridge;
pushing the attachment portion further so that the tip of the elastic sealing lip touches the bottom wall of the flange;
pushing the attachment portion even further so that the elastic sealing lip is deformed elastically in a direction opposite to an attachment portion pushing direction and the engagement portion of the second side wall is moved to such a position as to be able to engage with the lock portion of the flange; and
causing the elastic sealing lip to return to an original shape thereof due to elastic repulsive force of the elastically deformed elastic sealing lip, and thereby moving the attachment portion in a direction opposite to the attachment portion pushing direction and moving the engagement portion to the lock portion so that they are engaged with each other.

10. The long trim member attaching method according to claim 9, wherein elastic repulsive force of the elastic holding lip acts in addition to the elastic repulsive force of the elastic sealing lip in moving the engagement portion to the lock portion.

11. The long trim member attaching method according to claim 9, wherein the tip of the elastic sealing lip is not in contact with the bottom wall of the flange and a space is formed between them when the projection end of the projected flange portion passes the peak of the projection ridge.

12. A long trim member for vehicle to be attached to a flange that is provided at a periphery of an opening of a vehicle body panel and having a curved bottom wall and a projected flange portion, the long trim member including:
an attachment portion generally U-shaped in a cross section and having first and second side walls opposed to each other at a predetermined interval, a top wall integrally connecting the first and second side walls and an opening,
wherein the long trim member is attached to the flange in such a manner that the attachment portion is pushed toward a projection end of the projected flange portion of the flange through the opening thereof and the projected flange portion is thereby held from both sides,
characterized in that
the second side wall is formed with at least one elastic holding lip projecting from an inner surface of the second side wall toward a top wall side of an inner surface of the first side wall,
the first side wall is formed with a projection ridge projecting from a portion, closer to the top wall than a tip of the elastic holding lip, of the inner surface of the first side wall toward the inner surface of the second side wall and having a slide guide surface located on the side of the opening and forming an acute angle with the first side wall and an elastic sealing lip projecting and extending from an opening-side end of the first side wall toward the bottom wall of the flange,
the attachment portion is attached to the flange by pushing the attachment portion toward the projection end of the projected flange portion through the opening of the attachment portion in such a manner that a tip of the elastic sealing lip is kept not in contact with the bottom wall of the flange and a space is formed between them in a state that the slide guide surface of the projection ridge is in contact with the projection end of the projected flange portion and the tip of the elastic holding lip is in contact with a second-side-wall-side surface of the projected flange portion, that when the attachment portion is pushed further the slide guide surface is slid on the projection end of the projected flange portion while the elastic holding lip is deformed elastically toward the inner surface of the second side wall until the projection end of the projected flange portion passes a peak of the projection ridge, that when the attachment portion is pushed further the projected flange portion is held between the elastic holding lip and the projection ridge wherein the elastic holding lip exerting holding force of an elastic repulsive force to the projected flange portion, and that when the attachment portion is pushed even further the elastic sealing lip is deformed elastically in a direction opposite to an attachment portion pushing direction to attach the attachment portion and when the attachment portion is attached to the flange, an elastic repulsive force of the elastic sealing lip acting in a direction opposite to the attachment portion pushing direction, and
holding force of the elastic repulsive force of the elastic holding lip is set stronger than the elastic repulsive force of the elastic sealing lip.

13. A long trim member attaching method for attaching a long trim member to a flange that is provided at a periphery of an opening of a vehicle body panel and having a curved bottom wall and a projected flange portion, the long trim member being provided with an attachment portion generally U-shaped in a cross section and having first and second side walls opposed to each other at a predetermined interval and a top wall integrally connecting the first and second side walls and an opening, the second side wall being formed with at least one elastic holding lip projecting from an inner surface of the second side wall toward a top wall side of an inner surface of the first side wall, the first side wall being formed with a projection ridge projecting from a portion, closer to the top wall than a tip of the elastic holding lip, of the inner surface of the first side wall toward the inner surface of the second side wall and having a slide guide surface located on the side of the opening and forming an acute angle with the first side wall and an elastic sealing lip projecting and extending from an opening-side end of the first side wall toward the bottom wall of the flange, the long trim member attaching method for attaching the attachment portion to the flange by pushing the attachment portion toward the projection end of the projected flange portion through the opening of the attachment portion comprising the steps of:
establishing a state that a tip of the elastic sealing lip is not in contact with the bottom wall of the flange and a space is formed between them, the slide guide surface of the projection ridge is in contact with the projection end of the projected flange portion, and the tip of the elastic holding lip is in contact with a second-side-wall-side surface of the projected flange portion;
pushing the attachment portion so that the slide guide surface is slid on the projection end of the projected flange portion while the elastic holding lip is deformed elastically toward the inner surface of the second side wall until the projection end of the projected flange portion passes a peak of the projection ridge;
pushing the attachment portion further so that the projected flange portion is held between the elastic holding lip and the projection ridge;
pushing the attachment portion even further so that the elastic sealing lip is deformed elastically in a direction opposite to an attachment portion pushing direction; and
causing the elastically deformed elastic sealing lip to generate elastic repulsive force because it is urged to return to an original shape thereof.
